(19) United States
(12) Patent Application Publication
(10) Pub. No.: US 2011/0208557 A1
(43) Pub. Date: Aug. 25, 2011

(54) Supply and Demand Consolidation in Employee Resource Planning

(76) Inventors: Maria Teresa Gonzalez Diaz, Sunnyvale, CA (US); Cipriano A. Santos, Modesto, CA (US); Shailendra K. Jain, Sunnyvale, CA (US); K. Ravindra Kumar, Kamataka (IN); Madabushi Rangaramanujam, Bangalore (IN); Subramanya Gopikrishna Madle, Bangalore (IN); Rao Pradeep Sham, Karnataka (IN)

(21) Appl. No.: 13/124,831

(22) PCT Filed: Oct. 30, 2008
(86) PCT No.: PCT/US08/81803

§ 371 Date: Apr. 18, 2011

(51) Int. Cl. G06Q 10/00

(52) U.S. Cl. 705/7.14

(57) ABSTRACT

A method of employee resource planning includes consolidating and defining a demand for employee resources needed to accomplish a potential project in terms of a plurality of jobs and a supply of employee resources in terms of a plurality of employees, each job and each employee having a plurality of job attributes uniformly categorized into indices. Employees in the supply are mapped to corresponding jobs in the demand according to the job attributes.

### RELATED APPLICATIONS

The present application is currently being filed as a national stage in compliance with 35 U.S.C. 371 and claims the priority under 35 U.S.C. 119(a)-(d) or (f) and under C.F.R. 1.55(a) of previous International Patent Application No.: PCT/US2008/081803, filed Oct. 30, 2008, entitled “Supply and Demand Consolidation in Employee Resource Planning”, which application is incorporated herein by reference in its entirety.

### BACKGROUND

Most business entities and other organizations with large numbers of employees engage in some type of workforce management. Workforce management practices have the goal of ensuring adequate staffing in an organization and increasing the efficiency of workforce resource distribution among the various projects undertaken by the organization. These practices are typically based on a philosophy of maximizing the value of capital invested in compensating employees and achieving quality results from projects performed by the employees.

One particular problem that arises in workforce management is that of planning for the staffing needs of an organization despite uncertainty in workforce supply and demand. For example, it may be difficult to plan anticipated labor requirements and available employee resources for “funnel opportunities.” A funnel opportunity is an opportunity that, if realized, will quickly place much larger demands on an enterprise that has been the workload in the past. An example of a funnel opportunity may be a significant new job or contract that a company has bid on, but not yet won. Each funnel opportunity that is won becomes a project that requires resources.

Resource planning involves the allocation of workforce resources (generally employees and their time) to the projects undertaken by the enterprise. Resource planning will allocate resources according to the schedules and skills of the resources involved and the scheduling and requirements of the projects to which the resources are allocated. As can be imagined, this planning becomes a complex problem in situations where project demands are dictated by a dynamic environment and resources include a large numbers of employees.

### BRIEF DESCRIPTION OF THE DRAWINGS

The accompanying drawings illustrate various embodiments of the principles described herein and are a part of the specification. The illustrated embodiments are merely examples and do not limit the scope of he claims.

FIG. 1 is a block diagram of an illustrative employee resource planning system according to one exemplary embodiment of the principles described herein.

FIG. 2 is a flowchart of an illustrative method of employee resource planning according to one exemplary embodiment of the principles described herein.

FIG. 3 is a flowchart of an illustrative method of employee resource demand consolidation in an employee resource planning system according to one exemplary embodiment of the principles described herein.

FIG. 4 is a flowchart of an illustrative method of employee resource supply consolidation in an employee resource planning system according to one exemplary embodiment of the principles described herein.

FIG. 5 is a flowchart of an illustrative method of employee resource mapping in an employee resource planning system according to one exemplary embodiment of the principles described herein.

FIG. 6 is a block diagram representation of illustrative resource mapping in an employee resource planning system according to one exemplary embodiment of the principles described herein.

FIGS. 7A-7C are diagrams of illustrative qualified resource mapping in an employee resource planning system, according to one exemplary embodiment of the principles described herein.

FIG. 8 is a diagram of illustrative transitional resource mapping in an employee resource planning system, according to one exemplary embodiment of the principles described herein.

FIG. 9 is a diagram of an illustrative comparison between job attributes in an unqualified resource and a job in an employee resource planning system, according to one exemplary embodiment of the principles described herein.

Throughout the drawings, identical reference numbers designate similar, but not necessarily identical, elements.

### DETAILED DESCRIPTION

As described above, employee resource planning becomes a complex problem in situations where a large numbers of employees are being managed on a dynamic, constantly-evolving project list. Thus, in some situations, it may be desirable to provide a user-friendly, effective approach to employee resource planning.

To address these and other issues, the present specification discloses methods and systems of employee resource planning, wherein employee resources needed to accomplish a potential project and employee resources available to the potential project are each consolidated and defined in terms of a plurality of employees and jobs, respectively. Each employee and job has a plurality of job attributes categorized according to a uniform index. The consolidation of supply and demand may take into account factors such as projected attrition rates and dynamic demand factors. Employees defined in the employee resource supply are then mapped to jobs defined in the employee resource demand according to comparable job attributes, and a projected number of new employees needed in the employee resource supply are defined according to unmapped jobs in the employee resource demand.

By defining the supply and demand of the workforce resources in the same terms (Le. job attributes), a consolidation of the supply and demand may result in qualified and transitional employee resources being effectively and accurately matched with jobs in a project being planned prior to the commencement of the project, and with a correct assessment of hiring needs being made.

As used in the present specification and in the appended claims, many of the functional units described in the present specification have been labeled as “subsystems” in order to more particularly emphasize their implementation independence. For example, subsystems may be implemented by one or more processors executing software. An identified subsystem or subsystem of executable code may, for instance, include one or more physical or logical blocks of computer instructions that may, for instance, be organized as an object, procedure, or function. Nevertheless, the executables of an identified subsystem need not be physically located together, but may include disparate instructions stored in different locations which, when joined logically together, collectively form the subsystem and achieve the stated purpose for the subsystem. For example, a subsystem of executable code could be a single instruction, or many instructions, and may even be distributed over several different code segments, among different programs, and across several memory devices. In other examples, subsystems may be implemented entirely in hardware, or in a combination of hardware and software.

In the following description, for purposes of explanation, numerous specific details are set forth in order to provide a thorough understanding of the present systems and methods. It will be apparent, however, to one skilled in the art that the present systems and methods may be practiced without these specific details. Reference in the specification to “an embodiment,” “an example” or similar language means that a particular feature, structure, or characteristic described in connection with the embodiment or example is included in at least that one embodiment, but not necessarily in other embodiments. The various instances of the phrase “in one embodiment” or similar phrases in various places in the specification are not necessarily all referring to the same embodiment.

The principles disclosed herein will now be discussed with respect to illustrative systems and methods.

### Illustrative System

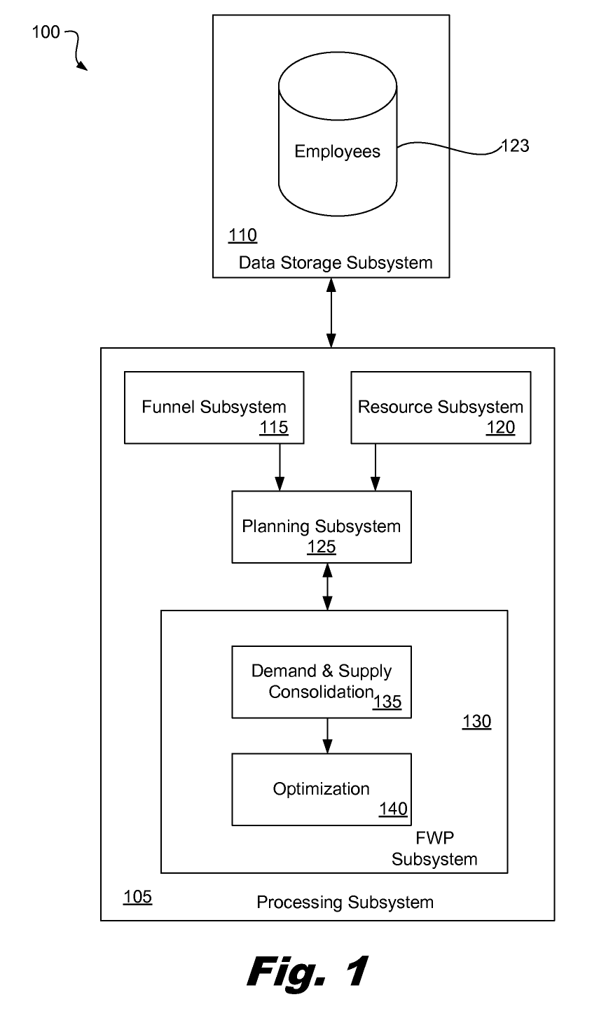

Referring now to FIG. 1, a block diagram of an illustrative employee resource planning system (100) is shown. The resource planning system (100) may include a processing subsystem (105) configured to process and generate data related to employee resource planning for a funnel opportunity and a data storage subsystem (110) configured to store data that is accessible to the processing subsystem (105). In certain embodiments, one or both of the processing subsystem (105) and the data storage subsystem (110) may be embodied in a plurality of networked computing devices. In other embodiments, the resource planning system (100) may be embodied on a single computing device. The functionality of the processing subsystem (105) and/or the data storage subsystem (110) may be embodied in executable code in a computer readable medium, such that a computer will perform the functionality of the processing subsystem (105) and/or the data storage subsystem (110) upon reading the executable code on the medium.

The processing subsystem (105) may include a funnel subsystem (115), a resource subsystem (120), a planning subsystem (125), and a funnel analysis and workforce planning (WFP) subsystem (130). The funnel subsystem (115) and the resource subsystem (120) may be communicatively coupled to the planning subsystem (125), and the planning subsystem (125) may, in turn, be communicatively coupled to the WFP subsystem (130).

The funnel subsystem (115) may be configured to allow the definition of employee resource demand within an opportunity development scheme. This definition may include details such as, but not limited to, division of the development scheme into periods, labor requirements by period, priorities in labor requirements, and job attributes in labor requirements. In certain embodiments, the employee resource demand may be dynamically defined by a computer algorithm or some other method for predicting dynamic demand. These details may be input and/or manipulated by a user through a user interface to the resource planning system (100),

The resource subsystem (120) may be configured to interact with and maintain data about a supply of current employee resources (e.g. personnel) stored in a database (123) of the data storage subsystem (110). These data may include definitions of employee qualifications based on job attributes, dates of availability of employees, dates of release of employees from ongoing projects, employee transitions (e.g. training, promotions, redeployment, etc.), and the like. The resource subsystem (120) may also be configured to allow a user to modify or manipulate the employee resource data through a user interface to the resource planning system (100).

The data stored and managed by the funnel subsystem (115) and the resource subsystem (120) may be available to the planning subsystem (125). The planning subsystem (125) may be configured to allow one or more users to create a planning scenario for the opportunity at hand by passing related data related to the WFP subsystem (130) from the funnel subsystem (115) and the resource subsystem (120) and receiving generated workforce sourcing plans from the WFP subsystem (130). The planning subsystem (125) may also allow users to manipulate or change different aspects of the employee resource planning scenario to compare different resultant workforce sourcing plans.

The WFP subsystem (130) may include a demand and supply consolidation module (135) and an optimization module (140). The demand and supply consolidation module (135) may be configured to receive data from the planning subsystem (125) for an opportunity being planned and consolidate all of the projected employee resource demand and employee resource supply for the opportunity. The optimization module (140) may then take the consolidated employee resource demand and supply from the demand and supply consolidation module (135) and map employees from the projected supply to jobs in the projected demand according to comparable job attributes of the employees and the jobs, as will be explained in more detail below. Through mapping, the optimization module (140) may also determine a list of openings not filled by the available employee resources, and for which new employees may be sought and hired.

### Illustrative Methods

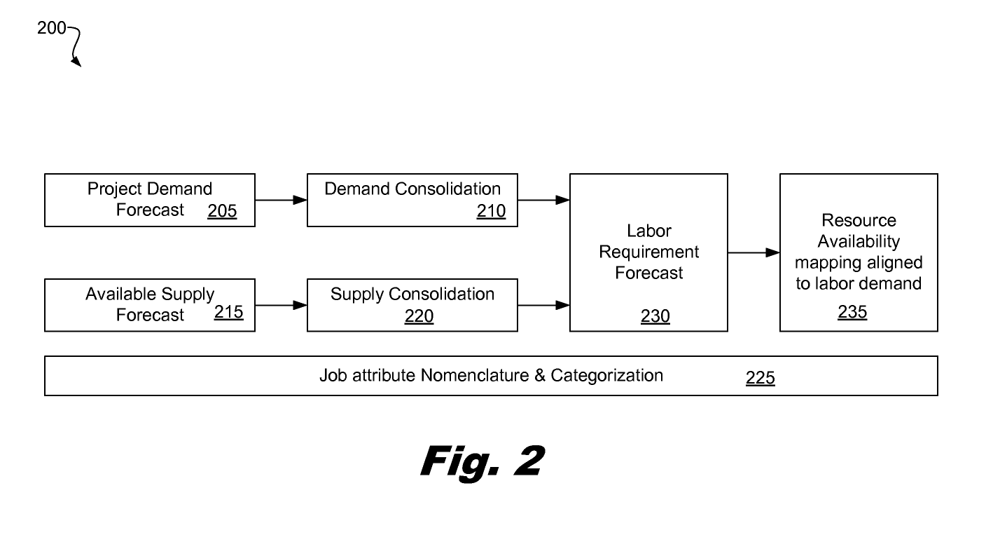

Referring now to FIG. 2, a flowchart of an illustrative method (200) of employee resource planning is shown. The method (200) may be performed, for example, by the resource planning system (100, FIG. 1) described above. In the method (200), demand for employee resources is forecast (step 205) and consolidated (step 210) parallel to the steps of forecasting (step 215) and consolidating (step 220) the available supply of employee resources. Both the demand for employee resources and the available supply of employee resources are expressed by a common nomenclature of job attributes (225), with each employee in the forecasted supply of employee resources and each job in the forecasted demand having a plurality of job attributes uniformly categorized into indices that are compatible and readily compared to each other.

Once the forecasted demand and supply of employee resources for the opportunity have been consolidated (steps 210, 220), a labor requirement forecast is created (step 230) and specific employees in the forecasted employee resource supply are mapped (step 235) to specific jobs in the forecasted employee resource demand according to the job attributes (225) corresponding to each of the employees and the jobs.

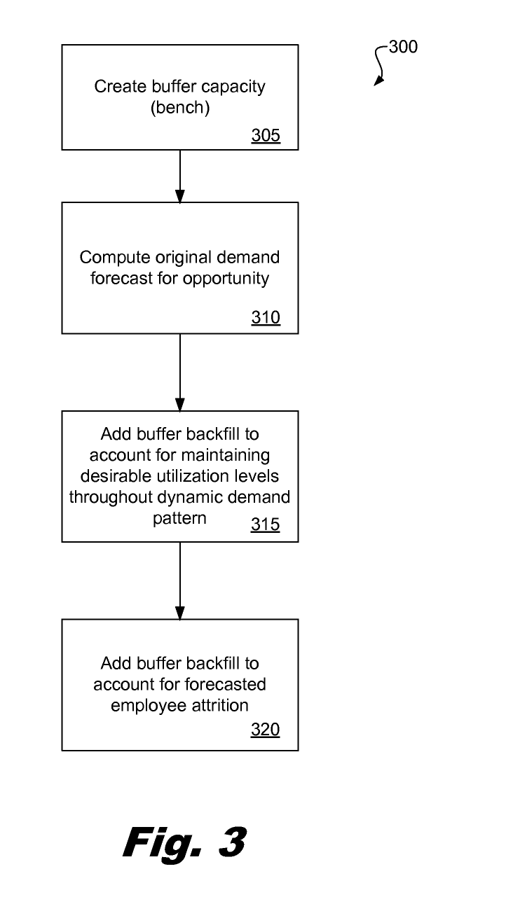

Referring now to FIG. 3, a flowchart of an illustrative method (300) of consolidating employee resource demand in an employee resource planning system is shown. The method (300) may be performed, for example, by the demand and supply consolidation module (135) in the processing subsystem (105) of the employee resource planning system (100) to determine an amount of employees needed to staff a particular opportunity. In the method (300), employee resource demand from the opportunity requirements is computed based on job attributes needed to staff the opportunity. These needed job attributes are compiled to create a group of jobs required to complete the requirements of the opportunity being planned.

This computation may be done by creating (step 305) a buffer capacity called a bench. A total labor forecast may be determined from computing (step 310) the original demand forecast for the opportunity and adding buffer backfill (step 315) to account for maintaining desirable utilization levels of the current employee resource capacity throughout a forecasted dynamic demand pattern for the opportunity, and adding buffer backfill (step 320) to account for forecasted employee attrition.

In certain embodiments, the calculation of the requirements from labor attrition may follow a binomial distribution B(a,N), where a is the attrition factor as the probability of the employee leaving and N is the number of employee resources that are qualified to perform the job. The number of expected replacements can then be calculated as nRe.qs=a*N, where nRegs represents the number of replacements required in a given period. For long term planning, this nReqs value can be distributed by periods using a cumulative rounding algorithm to forecast the number of replacement employees needed in a string of consecutive periods and forecast the demand for each period accordingly.

The computations from both of these mechanisms are then combined to compute (step 325) the total backfill requirements for the buffer of employee resources. These requirements are expressed in terms of job attributes categorized by a uniform index.

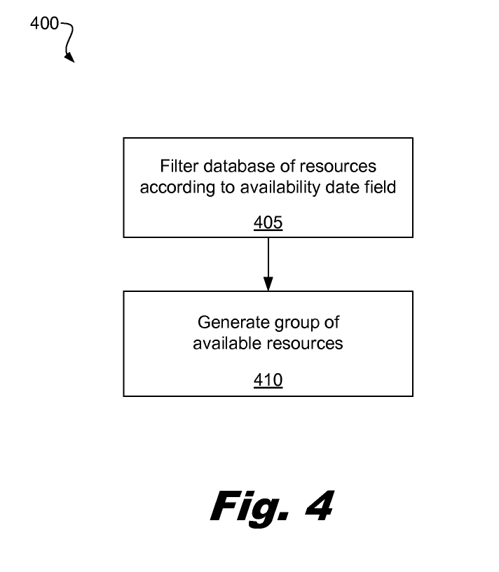

Referring now to FIG. 4, a flowchart of an illustrative method (400) of consolidating employee resource supply in an employee resource planning system is shown. The method (400) includes filtering (step 405) a database of all employee resources in a system according to an availability date field. For example, the database of employee resources may be filtered according to an anticipated date of beginning a new opportunity or a new period in an existing opportunity. A group of available employee resources may be generated (step 410). The group may include those employees who were found to be available for assignment to an opportunity before the anticipated start date of the new opportunity or period.

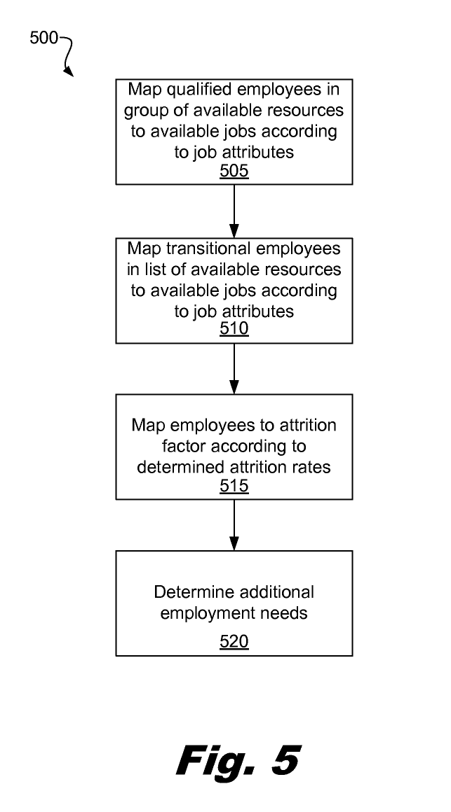

Referring now to FIG. 5, a flowchart of an illustrative method (500) of employee resource mapping in an employee resource planning system is shown. The method (500) may be used to allocate employees in a consolidated employee resource supply, such as that created according to the method (400, FIG. 4) of FIG. 4, to available jobs in a consolidated employee resource demand, such as that created according to the method (300, FIG. 3) of FIG. 3, The method (500) may include mapping (step 505) qualified employees in the consolidated employee resource supply to available jobs in the consolidated demand according to comparable job attributes corresponding to both the employees and the jobs. Then, transitional employees in the consolidated supply are mapped (step 510) to available jobs in the consolidated demand according to anticipated qualification for those jobs based on the comparable job attributes corresponding to both the employees and the jobs.

In certain embodiments, multiple employees in the consolidated supply may be qualified for the same job. Conversely, some employees in the consolidated supply may be available for more than one job, One approach to such cases may include mapping each employee to the available job with the most stringent job attribute requirements for which he or she qualifies.

Additionally, it may often be the case that not all of the employees in the group of available employee resources are mapped to a job in the opportunity being planned. In such cases, those employees not allocated to the opportunity may be made available to other opportunities or projects, as may suit a particular application of the principles described herein.

The method (500) may also include the step of mapping (step 515) certain employees in the consolidated supply of employee resources to an attrition factor to account for expected attrition. Attrition rates for different types of employees may be determined according to job attributes associated with the employees, The number of employees lost from the consolidated supply of employee resources prior to the start of the opportunity may then be calculated using the attrition rates of the various types of employees in the supply.

Once the qualified employees, transitional employees, and anticipated attrition have been mapped (steps 505, 510, 515), it can then be determined (step 520) what additional employment needs exist based on unmapped jobs in the consolidated employee resource demand. Job descriptions for new positions can be determined by examining the required job attributes of these unmapped jobs, and new employees that are qualified for those positions can be sought prior to the commencement of the opportunity being planned.

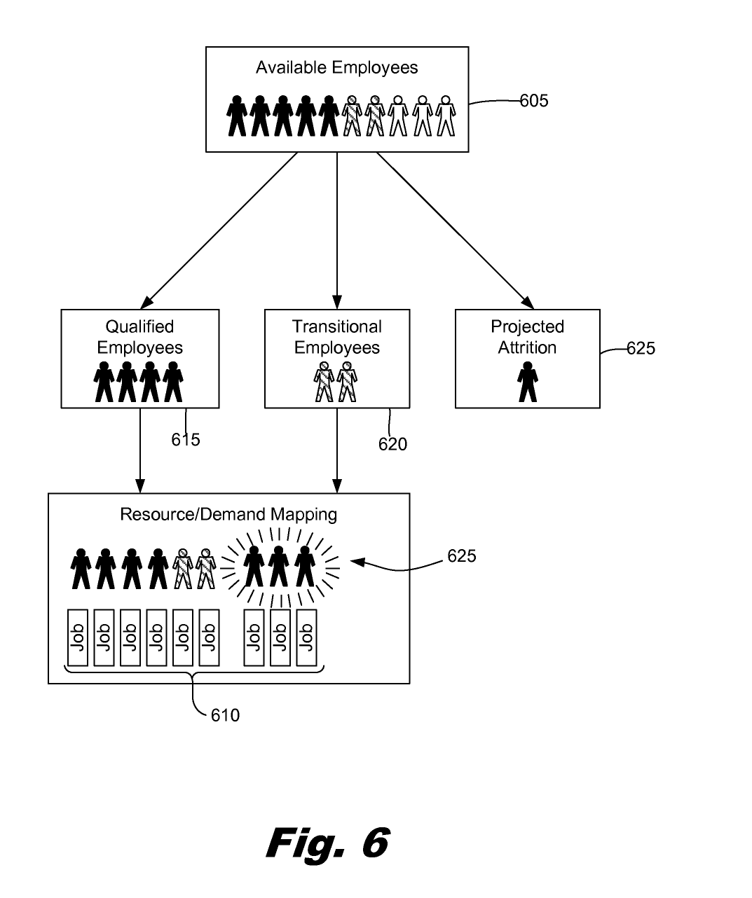

Referring now to FIG. 6, a diagram representation of illustrative employee resource mapping is shown according to the principles described above. Employees (605) in the consolidated employee resource supply may be taken and mapped to specific jobs (610) in the consolidated demand for the opportunity being planned. Out of this pool of available employees (605), a first group (615) will be mapped to specific jobs (610) for which each employee in the first group is determined to be qualified. A second group of employees (620) may include transitional employees that are mapped to specific jobs (610) for which it is anticipated that they will become qualified (610) by training, promotion, or some other means, as described above. A third group of employees (625) may be mapped to a projected attrition factor and disassociated with the jobs (610) in the consolidated employee resource demand.

By examining the unmapped jobs (610) in the consolidated employee resource demand, a projected number of new employees (625) needed in the group of available employee resources may be defined. Job requirements for these new employees (625) may be defined by the job attributes of the unmapped jobs (610) such that the new employees may be mapped to the unmapped jobs (610), thus ensuring that the demand for employee resources is met.

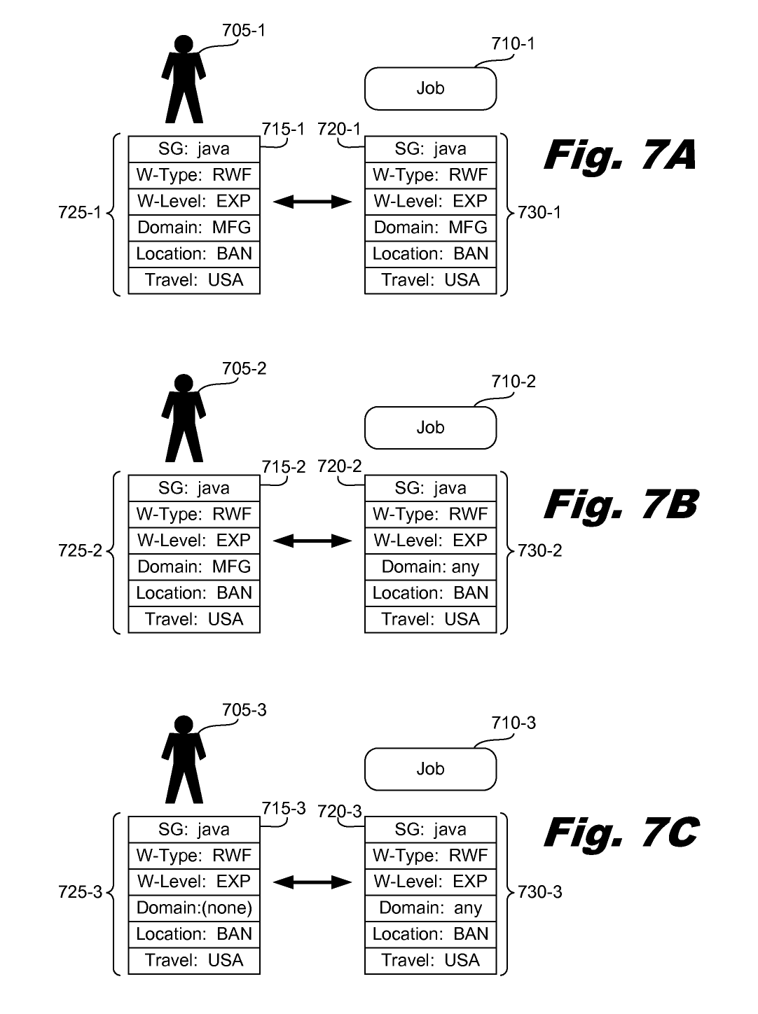

Referring now to FIGS. 7A-7C, various examples of mapping a qualified employee resource (705-1 to 705-3) to an available job (710-1 to 710-3) in the consolidated resource demand are shown. As has been explained above, the mapping is done within the context of job attributes (715-1 to 715-3) associated with the employee resource (705-1 to 705-3) and required job attributes (720-1 to 720-3) associated with the available job (710-1 to 710-3), The job attributes (715-1 to 715-3) of both the employee resource (705-1 to 705-3) and the available job (710-1 to 710-3) may be uniformly organized into indices (725-1 to 725-3, 730-1 to 730-3) to facilitate direct comparison between the job attributes (715-1 to 715-3) of the employee (705-1 to 705-3) and the job attributes (720-1 to 720-3) of the available job (710-1 to 710-3).

In the present example, the indices (725-1 to 725-3, 730-1 to 730-3) categorically organize job attributes by skill group (SG), workforce type (\N-Type), workforce level (W-Level), domain, location, and ability to travel. The job attributes of the employee (705-1 to 705-3) and the requirements of available job (710-1 to 710-3) are represented by individual values stored in each of the categories of the indices (725-1 to 725-3, 730-1 to 730-3). Thus, comparisons can be made between an employee's qualifications and a job's requirements by categorically comparing the values stored in the indices (725-1 to 725-3) of the employee (705-1 to 705-3) and the values stored in the indices (730-1 to 730-3) of the available job (710-1 to 710-3). In other embodiments, the job attributes (715-1 to 715-3, 720-1 to 720-3) may be different from those shown in FIGS. 7A-7C and organized into indices as may best suit a particular application of the principles herein.

In the example of FIG. 7A, an employee (705-1) in the group of available resources includes the following job attributes (715-1): Java programming skill group, regular work force (RWF), is classified as experienced (EXP), specializes in the manufacturing (MFG) domain, is located in Bangalore (BAN), and is able to travel to the United States. The job (710-1) to which the employee (705-1) is being mapped includes verbatim each of the attributes of the employee (705-1) in the required job attributes (720-1). Thus, the employee (705-1) is qualified for the available job (710-1) and is mapped thereto.

In the example of FIG. 7B, an employee (705-2) has the same attributes as the employee (705-1) of FIG. 7A. The job (710-2) to which the employee (705-2) is being matched requires each of the job attributes (715-2) of the employee (705-2), with the exception of the job attribute categorized as the work domain. With regard to the domain of the employee (705-2), the job (710-2) makes no specification, therefore resulting in any employee domain attribute meeting the domain requirement of the job (710-2). The employee (705-2) is thus qualified for the available job (710-2) and mapped thereto.

The example of FIG. 70 is identical to that of FIG. 7B, except the employee (705-3) has no domain attribute specified at all. As the job (710-3) imposes no domain requirement on the employee (705-3) and the employee (705-3) meets all other requirements for the job (710-3), the employee (705-3) is qualified for the available job (710-3) and mapped thereto.

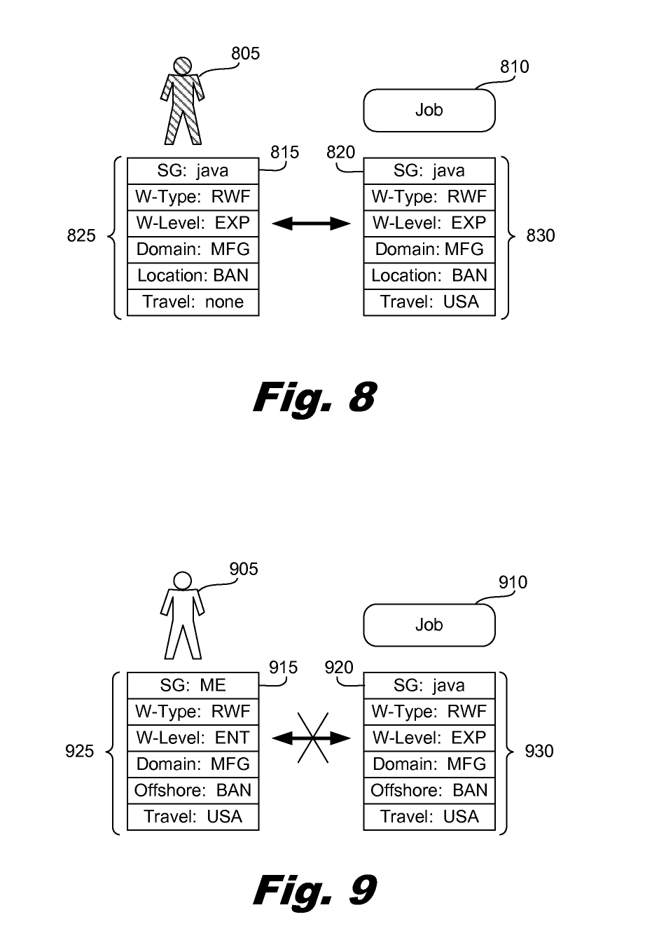

Referring now to FIG. 8, an example is shown of mapping a transitional employee (805) in the group of available employee resources to an available job in the consolidated resource demand. In the present example, the employee (805) has job attributes (815) in an index (825) that meet all of the requirements imposed by job attributes (820) in an index (830) of the available job (810) except for that of the travel job attribute. In this regard, the available job (810) requires that a qualifying employee be able to travel to the United States, whereas the employee (805) is currently not able to travel anywhere, However, it may be possible for the employee (805) to become able to travel to the United States prior to the beginning of the opportunity of which the available job (810) is a part. In such a case, the employee (805) can be classified as a transitional employee (805) and mapped to the job (810) for which it is anticipated that the employee (805) will qualify.

Referring now to FIG. 9, an example is shown of an employee (905) that is not mapped to an available job (910) due to failure to qualify for the job (910), In the present example, the job attributes (915) defined in the index (925) of the employee (905) meet the workforce type, domain, location and travel requirements imposed by the job attributes (920) in the index (930) of the available job (910), but fail to meet the skill group and workforce level requirements imposed by the job attributes (920) of the available job (910). Because it is not anticipated that the employee (905) will change his or her skill group prior to the start of the opportunity of which the job (910) is a part, the employee (905) is considered unqualified for the available job (910) and is not mapped thereto.

The preceding description has been presented only to illustrate and describe embodiments and examples of the principles described. This description is not intended to be exhaustive or to limit these principles to any precise form disclosed. Many modifications and variations are possible in light of the above teaching.

What is claimed is:

1. A method of employee resource planning, comprising:
consolidating and defining a demand for employee resources needed to accomplish a potential project in terms of a plurality of jobs and a supply of employee resources in terms of a plurality of employees each said job and each said employee comprising a plurality of job attributes uniformly categorized into indices: and
mapping employees in said supply to corresponding jobs in said demand according to said job attributes.

2. The method of claim 1, further comprising defining a projected number of new employees needed in said supply according to unmapped jobs in said demand.

3. The method of claim 1, wherein said mapping comprises mapping at least one employee in said supply to a job in said demand for which said at least one employee will be qualified according to said job attributes.

4. The method of claim 1, further comprising adjusting said demand for employee resources according to an anticipated attrition of employees throughout said project.

5. The method of claim 1, further comprising adjusting said supply of employee resources according to an anticipated attrition of employees prior to a commencement of said project.

6. A system of workforce resource planning, comprising:
a data storage subsystem configured to store a database of a supply of employee resources in terms of a plurality of employees, each employee comprising a plurality of job attributes uniformly categorized into indices; and
a processing subsystem in communication with said data storage subsystem and configured to:
consolidate and define a demand for employee resources needed to accomplish a potential project in terms of a plurality of jobs, each said job comprising a plurality of job attributes uniformly categorized into indices;
consolidate said supply of employee resources; and
map employees in said supply to corresponding jobs in said demand according to said job attributes.

7. The system of claim 6, wherein said consolidating and defining said demand for employee resources comprises creating a bench forecast by determining a need for employee resources to fulfill an optimal utilization according to an anticipated dynamic demand pattern of said project and determining an anticipated amount of employee attrition.

8. The system of claim 6, wherein said mapping comprises mapping at least one employee in said supply to a job in said demand for which said at least one employee is found to be qualified according to said job attributes.

9. The system of claim 6, wherein said mapping comprises mapping at least one employee in said supply to a job in said demand for which it is anticipated that said at least one employee will be qualified prior to a commencement of said project according to said job attributes.

10. The system of claim 6, further comprising adjusting said demand for employee resources according to an anticipated attrition of employees throughout said project.

11. The system of claim 6, further comprising adjusting said supply of employee resources according to an anticipated attrition of employees prior to a commencement of said project.

12. The system of claim 6, further comprising a user interface.

13. The system of claim 12, wherein said user interface allows a user to define demand factors and a uniform categorization of said plurality of job attributes.

14. A computer program product for employee resource planning, comprising:
a computer usable medium having computer usable program code embodied therewith, said computer usable program code comprising:
computer usable program code configured to consolidate and define a demand for employee resources needed to accomplish a potential project in terms of a plurality of jobs and a supply of employee resources in terms of a plurality of employees, each said job and each said employee comprising a plurality of job attributes uniformly categorized into indices; and
computer usable program code configured to map employees in said supply to corresponding jobs in said demand according to said job attributes.

15. The computer program product of claim 14, further comprising computer usable program code configured to define a projected number of new employees needed in said supply according to unmapped jobs in said demand.
